(19) United States
(12) Patent Application Publication
(10) Pub. No.: US 2008/0275850 A1
(43) Pub. Date: Nov. 6, 2008

(54) IMAGE TAG DESIGNATING APPARATUS, IMAGE SEARCH APPARATUS, METHODS OF CONTROLLING OPERATION OF SAME, AND PROGRAMS FOR CONTROLLING COMPUTERS OF SAME

(76) Inventor: Arito ASAI, Asaka-shi (JP)

Correspondence Address: BIRCH STEWART KOLASCH & BIRCH, PO BOX 747, FALLS CHURCH, VA, 22040-0747, US

(21) Appl. No.: 12/047,706

(22) Filed: Mar. 13, 2008

(30) Foreign Application Priority Data
Mar. 15, 2007 (JP) 2007-065958

(51) Int. Cl. G06F 17/30; G06F 12/00

(52) U.S. Cl. 707/3; 707/102; 711/100; 707/E17.123; 711/E12.042

(57) ABSTRACT

An appropriate tag is assigned to an image in comparatively simple fashion. An image of interest to be tagged is selected and tags that have already been assigned to the selected image of interest are displayed in a present-tag display area. Tags having a high frequency of appearance are extracted from among tags that have been assigned to images having tags identical with the tags that have already been assigned to the image of interest, these images being taken from among images that have been stored in an image database. The extracted tags are displayed in a tag candidate display area as candidate tags. Since the tags displayed in the tag candidate display area often are tags related to the selected image of interest, they are tags suitable for assignment to the image of interest.

### BACKGROUND OF THE INVENTION

1. Field of the Invention

This invention relates to an image tag designating apparatus, an image search apparatus, methods of controlling the operation of these apparatuses, and programs for controlling computers of these apparatuses.

2. Description of the Related Art

In order to search for images at an online album site on the Internet, etc., images are tagged with character strings (see the specification of Japanese Patent Application Laid-Open No. 2005-33347).

However, inputting tags and assigning them to each and every image one by one is troublesome. Since tags are selected from a list of tags used generally, there are many instances where a tag suited to an image cannot always be selected. In addition, in a search of images, only an image that is a perfect match with an entered tag is found as a hit. This means that it may be difficult to find a desired image.

### SUMMARY OF THE INVENTION

An object of the present invention is to make it comparatively simple to tag an image.

Another object of the present invention is find an image comparatively simply.

According to a first aspect of the present invention, there is provided a tag designating apparatus comprising: a first display control device (means) for controlling a display unit so as to display an image of interest, to which a tag representing image attribute information will be assigned, on a display screen; a second display control device (means) for controlling the display unit in such a manner that second tags different from first tags are displayed on the display screen as tags serving as candidates for assignment to the image of interest, wherein the second tags are from among tags that have been assigned to a number of stored images, other than the image of interest, stored in an image database, these stored images having tags identical with the first tags that have already been assigned to the image of interest; and a tag designating device (means) for designating a tag, which will be assigned anew to the image of interest, from among the second tags displayed on the display screen by the second display control device.

The first aspect of the present invention also provides an operation control method suited to the above-described tag designating apparatus. Specifically, a method of controlling operation of a tag designating apparatus comprises the steps of: controlling a display unit so as to display an image of interest, to which a tag representing image attribute information will be assigned, on a display screen; controlling the display unit in such a manner that second tags different from first tags are displayed on the display screen as tags serving as candidates for assignment to the image of interest, wherein the second tags are from among tags that have been assigned to a number of stored images, other than the image of interest, stored in an image database, these stored images having tags identical with the first tags that have already been assigned to the image of interest; and designating a tag, which will be assigned anew to the image of interest, from among the second tags displayed on the display screen.

The first aspect of the present invention also provides a program for implementing the above-described operation control method.

In accordance with the present invention, an image of interest is displayed on the display screen of a display unit. A number of images have been stored in an image database, and first tags have already been assigned to the image of interest. From among tags that have been assigned to the number of stored images having tags identical with the first tags, second tags different from the first tags are displayed on the display screen as tags that are candidates for assignment to the image of interest. A tag assigned to the image of interest anew is designated from among the displayed second tags. In accordance with the first aspect of the present invention, tags suitable for assignment to the image of interest are displayed as tags (second tags) serving as candidates for assignment to the image of interest. A tag suited to the image of interest can be decided merely by designating the desired tag from among the displayed candidate tags.

The apparatus may further comprise at least one of a tag storage device (means) for storing a tag, which has been designated by the tag designating device, in association with the image of interest, and a transmitting device (means) for transmitting data, which represents the tag designated by the tag designating device, to a server in association with the image of interest.

If the image tag designating apparatus is an independent apparatus that does not communicate with another apparatus, the tag storage device would be provided. If the image tag designating apparatus is an apparatus that communicates with another apparatus, then the tag transmitting device would be provided.

According to a second aspect of the present invention, there is provided an image search apparatus comprising: a tag input device (means) for inputting a tag representing image attribute information; a first display control device (means) for controlling a display unit in such a manner that images represented by image data, to which the tag that has been input from the tag input device has been assigned, will be displayed on a display screen, wherein the image data is from among image data that has been stored in an image database; a second display control device (means) for controlling the display unit in such a manner that, from among tags that have been assigned to the images displayed on the display screen under the control of the first display control device, tags with the exception of the tag that has been input from the tag input device are displayed on the display screen as search candidate tags; a tag designated device (means) for designating a desired search candidate tag from among the search candidate tags displayed on the display screen under the control of the second display control device; and a third display control device (means) for controlling the display unit in such a manner that images represented by image data to which the tag designated by the tag designating device has been assigned will be displayed on the display screen, the image being from among the image data that has been stored in the image database.

The second aspect of the present invention also provides an operation control method suited to the above-described image search apparatus. Specifically, a method of controlling operation of an image search apparatus comprises the steps of: inputting a tag representing image attribute information; controlling a display unit in such a manner that images represented by image data, to which the tag that has been input has been assigned, will be displayed on a display screen, wherein the image data is from among image data that has been stored in an image database; controlling the display unit in such a manner that, from among tags that have been assigned to the images displayed on the display screen, tags with the exception of the tag that has been input are displayed on the display screen as search candidate tags; designating a desired search candidate tag from among the search candidate tags displayed on the display screen; and controlling the display unit in such a manner that images represented by image data to which the designated tag has been assigned will be displayed on the display screen, the image data being from among the image data that has been stored in the image database.

The second aspect of the present invention also provides a program for implementing the above-described operation control method.

In accordance with the second aspect of the present invention, a tag representing image attribute information is entered. Images represented by image data to which the entered tag has been assigned are displayed on the display screen of a display unit, the image data being from among image data that has been stored in an image database. Tags from which the tag that has been input from the tag input device is excluded are displayed on the display screen as search candidate tags from among tags that have been assigned to the images displayed on the display screen. A desired tag is designated from among the displayed search candidate tags. Image data to which the designated tag has been assigned is found from the image database and displayed on the display screen of the display unit. In accordance with the second aspect of the present invention, tags related to an initially input tag are displayed as search candidate tags. As a result, a desired tag can be designated from among the displayed search candidate tags and images to which the designated tag has been assigned can be found. A desired image can be found comparatively simply.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a block diagram illustrating the electrical configuration of an image search apparatus according to a first embodiment of the present invention;

FIG. 2 illustrates an example of data that has been stored in a tag database according to this embodiment;

FIG. 3 illustrates an example of a tag add-on window according to this embodiment;

FIG. 4 illustrates an example of a tag add-on window according to this embodiment;

FIG. 5 is a flowchart illustrating processing for adding on a tag according to this embodiment;

FIG. 6 is a block diagram illustrating the electrical configuration of an image search apparatus according to a modification of the first embodiment;

FIG. 7 is a flowchart illustrating processing for adding on a tag according to the modification;

FIG. 8 illustrates an example of a search window according to a second embodiment of the present invention;

FIG. 9 illustrates an example of a search window according to the second embodiment;

FIG. 10 is a flowchart illustrating image search processing according to the second embodiment; and

FIG. 11 s a flowchart illustrating image search processing according to a modification of the second embodiment.

### DESCRIPTION OF THE PREFERRED EMBODIMENTS

Preferred embodiments of the present invention will now be described in detail with reference to the accompanying drawings.

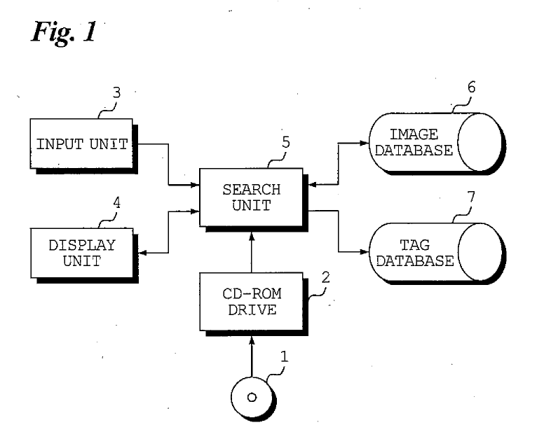

FIG. 1, which illustrates a first embodiment of the present invention, is a block diagram showing the electrical configuration of an image search apparatus (image tag designating apparatus) that is capable of endowing an image with a tag representing attribute information of an image.

The image search apparatus is provided with a CD-ROM (Compact Disk—Read-Only Memory) drive 2. By loading a CD-ROM 1 containing an operating program for performing an operation, described later, in the CD-ROM drive 2, the operating program is read and installed in the image search apparatus.

The image search apparatus is provided with an input unit 3. Input of identification data (image file name, etc.) specifying an image to be tagged, input of a tag and selection of a tag, etc., are performed by the input unit 3. Data and commands, etc., that have been entered from the input unit 3 are input to a search unit 5.

The image search apparatus is also provided with a display unit 4. Displayed on the display screen of the display unit 4 are an image to be tagged, tags that has already been assigned to the image to be tagged, a section for inputting a tag and tags recommended for tag assignment.

The image search apparatus includes an image database 6 in which a number of items of image data representing images displayed on the display screen of the display unit 4 have been stored, and a tag database 7 in which data representing tags that have been assigned to images has been stored.

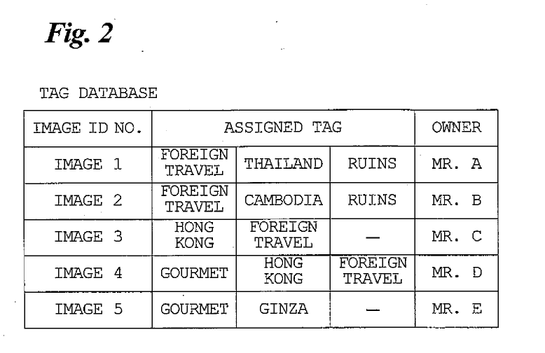

FIG. 2 illustrates an example of data that has been stored in the tag database 7.

Tag data that has been assigned to images has been stored in the tag database 7, as mentioned above. The tag data has been stored in the tag database 7 in association with image identification numbers that identify the images to which the tag data has been assigned. Information concerning the owners of the images also has been stored in the tag database 7. For example, tags that have been assigned to an image of Image ID No. 1 are three in number, namely “FOREIGN TRAVEL”, “THAILAND” and “RUINS”, and tags that have been assigned to an image of Image ID No. 3 are two in number, namely “HONG KONG” and “FOREIGN TRAVEL”.

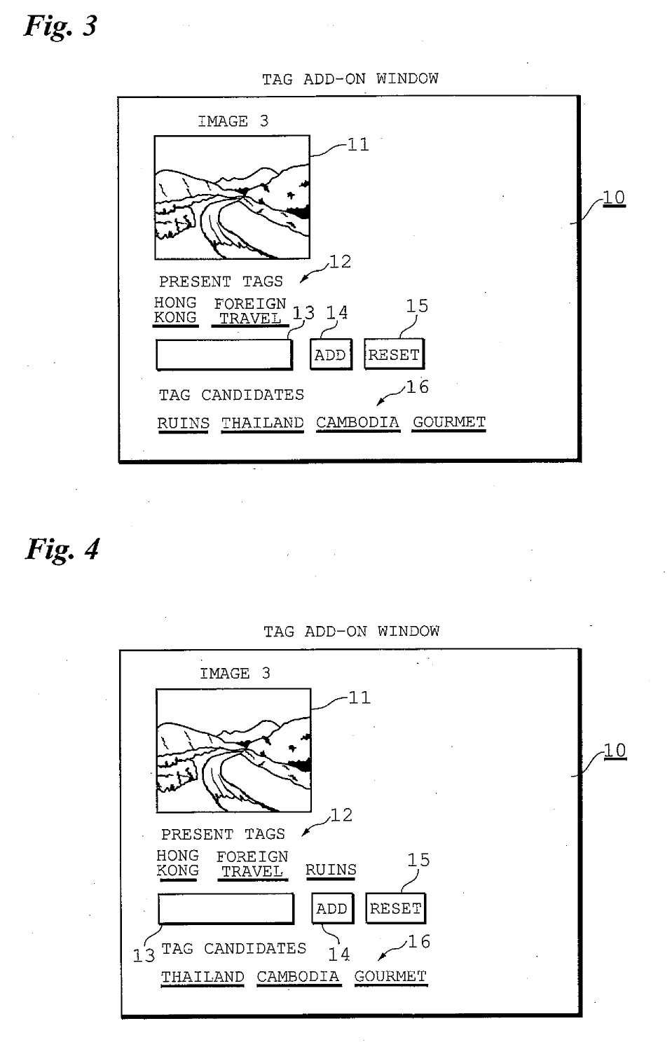

FIG. 3 illustrates an example of a tag add-on window 10 displayed on the display screen of the display unit 4.

The tag add-on window 10 includes an image display area 11, a present-tag display area 12, a tag input area 13, and add-on area 14, a reset area 15 and a tag candidate display area 16.

An image of interest to which a tag is to be assigned is displayed in the image display area 11. Tags (first tags) that have already been assigned to the image of interest being displayed in the image display area 11 are displayed in the present-tag display area 12. A tag that has been input from the input unit 3 is displayed in the tag input area 13. The add-on area 14 is capable of being clicked. By clicking the add-on area 14, a tag that has been input to the tag input area 13 is added on as a tag of the image being displayed in the image display area 11. The reset area 15 also is capable of being clicked. By clicking the reset area 15, a tag that has been input to the tag input area 13 is reset. Displayed in the tag candidate display area 16 are tags (second tags) recommended for assignment to the image being displayed in the image display area 11. If a tag being displayed in the tag candidate display area 16 is clicked, the clicked tag is displayed in the tag input area 13.

It goes without saying that clicking of the add-on area 14, reset area 15 and tag candidate display area 16 is performed by a mouse with which the input unit 3 is provided. Naturally, it may be so arranged that if the tag add-on window 10 is provided with a touch-sensitive panel, input of an add-on command, input of a reset command and tag selection, etc., can be achieved by touching the add-on area 14, reset area 15 or a tag being displayed in the tag candidate display area 16.

FIG. 4 illustrates an example of the tag add-on window to which a tag has been added.

In the tag add-on window 10 shown in FIG. 3, it is assumed that the tag “RUINS” included in the tag candidate display area 16 has been selected by the user. The tag “RUINS” is assigned as a tag of the image being displayed in the image display area 11. Accordingly, the tag “RUINS” is added on anew and displayed in the present-tag display area 12, as depicted in FIG. 4. The tag “RUINS” that has been added on vanishes from the tag candidate display area 16.

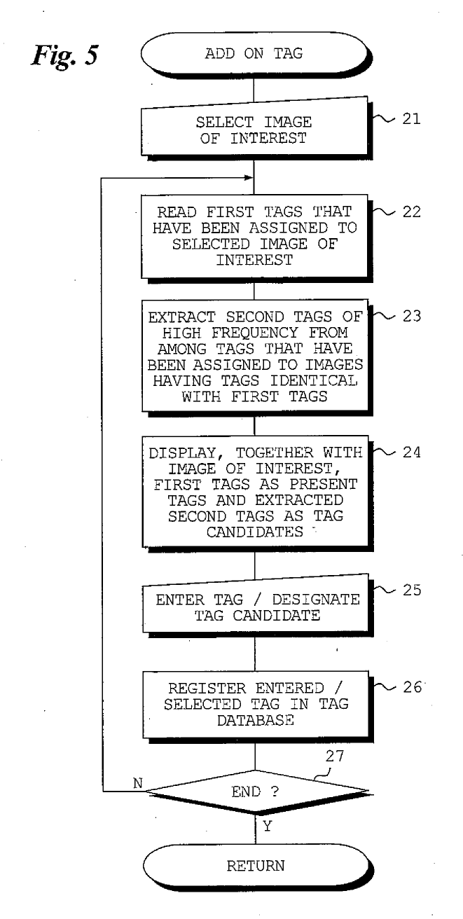

FIG. 5 is a flowchart illustrating processing for adding on a tag in the image search apparatus.

First, an image of interest to which a tag is to be assigned by the input unit 3 is selected as by specifying the name of the image file (step 21). When this is done, tags (first tags) that have been assigned to the selected image are read from the tag database 7 (step 22). Tags (second tags) exhibiting a high frequency of having being assigned are extracted from among tags that have been assigned to images having tags identical with the read first tags (step 23).

Since the read first tags are tags presently assigned to the selected image of interest, they are displayed in the present-tag display area of the add-on window 10, the extracted second tags are displayed in the tag candidate area of the add-on window 10 as recommended tag candidates, and the image of interest is displayed in the image display area (step 24). Entry of a tag or designation of a tag to be added on from among the tags displayed in the tag candidate area is performed by the user (step 25). The entered tag or the selected tag is registered in the tag database 7 in association with the image identification number (step 26). The processing of steps 22 to 26 is repeated until tag add-on processing ends (step 27).

When a tag is added on, the added tag becomes a tag assigned to the selected image of interest and it is displayed in the present-tag display area 12 as a present tag. The added tag is removed from the tag candidates.

In the tag add-on window 10 shown in FIG. 3, the present tags that have been assigned to the image being displayed in the image display area 11 are “HONG KONG” and “FOREIGN TRAVEL”. Images having tags identical with the tags “HONG KONG” or “FOREIGN TRAVEL” are the images having Image ID Nos. 1, 2, 3 and 4. The tags that have been assigned to these images are “THAILAND” and “RUINS” (the image of Image ID No. 1), “CAMBODIA” and “RUINS” (the image of Image ID No. 2), and “GOURMET” (the image of Image ID No. 4) when the tags that have been assigned to the image of interest are excluded. From among these tags (the second tags), the tag having the highest frequency of appearance is “RUINS”, and the tags having the next highest frequency of appearance are “THAILAND”, “CAMBODIA” and “GOURMET”. These tags “RUINS”, “THAILAND”, “CAMBODIA” and “GOURMET” of high frequency, which have a frequency of appearance greater than a prescribed number, are displayed in the tag candidate display area 16 as tag candidates (FIG. 3). If “RUINS” is selected as the additional tag of the image of interest, then the selected tag “RUINS” is stored in the tag database 7 in association with the Image ID No. 3 of the image of interest (FIG. 4).

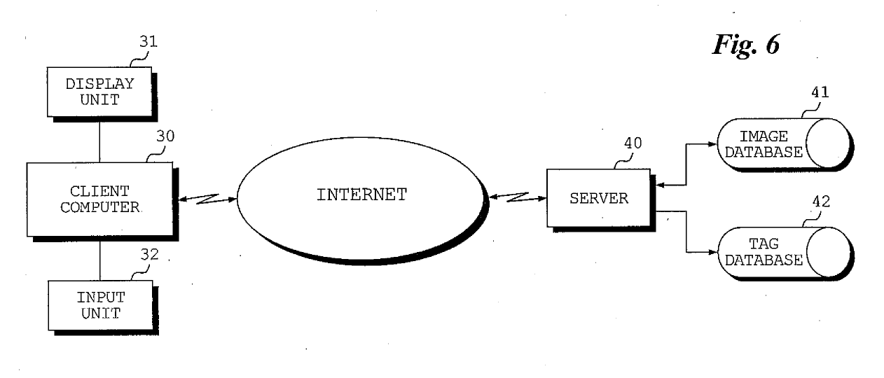

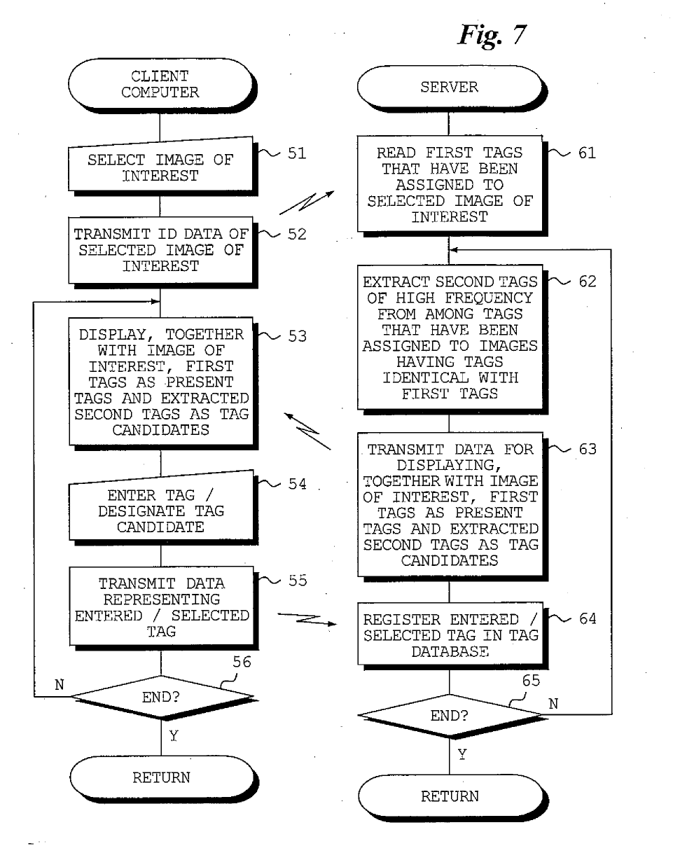

FIGS. 6 and 7 illustrate a modification.

In the embodiment described above, the tag database 7, etc., and the input unit 3, etc., are included in a single image search apparatus. Described next, however, is an arrangement in which an image is tagged while accessing a server, to which an image database has been connected, utilizing the Internet.

A display unit 31 and an input unit 32 are connected to a client computer 30. The client computer 30 can be connected to a server 40 via a network such as the Internet. An image database 41 and a tag database 42 are connected to the server 40.

FIG. 7 is a flowchart illustrating processing executed by the client computer and server.

The client computer 30 accesses the server 40 and selects an image of interest from among images represented by image data that has been stored in the image database 41 (step 51). Naturally, an image of interest may be selected from among images represented by image data that has been stored in the client computer 30. Identification data of the selected image of interest is transmitted from the client computer 30 to the server 40 (step 52).

When the identification data of the image of interest is received by the server 40, first tags that have been assigned to the selected image of interest are read from the tag database 42 (step 61). Second tags of high frequency of appearance are extracted in a manner similar to that described above from among second tags that have been assigned to images having tags identical with the read first tags (step 62). The server 40 generates data for displaying, together with the image of interest, the first tags as the present tags and the extracted second tags as the tag candidates in the form of the add-on window, and transmits this data to the client computer 30 (step 63).

When this is done, the add-on window in which the first tags appear as the present tags, the extracted second tags appear as the tag candidates and which includes the selected image is displayed on the display screen of the display unit 31 of client computer 30 (step 53). Entry of a tag to be added on or selection of a tag from the tag candidates is performed (step 54) and data representing the entered tag or selected tag is transmitted from the client computer 30 to the server 40 (step 55).

When data representing the tag transmitted from the client computer 30 is received by the server 40, the received data representing the tag is registered in the tag database 42 (step 64).

The processing of steps 51 to 55 and the processing of steps 61 to 64 is repeated until tag add-on processing ends (steps 56, 65).

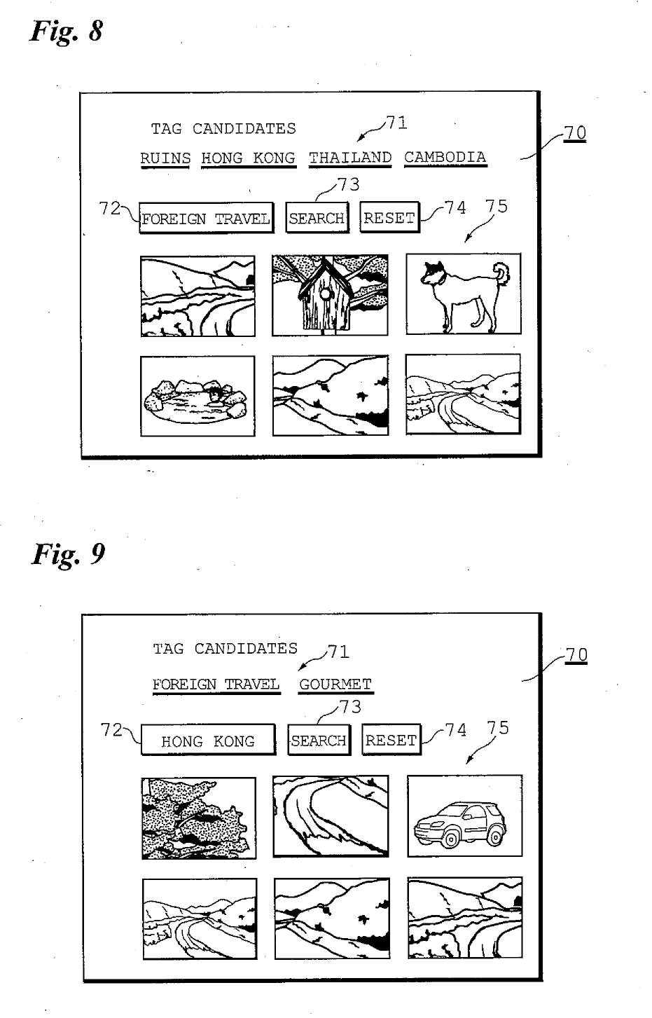

FIGS. 8 to 11 illustrate another embodiment and relate to an image search apparatus. The electrical components of the image search apparatus of this embodiment are the same as those shown in FIG. 1.

FIGS. 8 and 9 illustrate examples of a search window 70 displayed in an image search.

The search window 70 is provided with a tag candidate display area 71, a tag input area 72, a search area 73, a reset area 74 and an image display area 75.

The image display area 75 is an area in which images represented by image data having already entered tags (image search keywords) is displayed. This image data is from image data that has been stored in the image database 6. The tag candidate display area 71 is an area for displaying tag candidates believed to be utilized when finding an image relating to images found based upon an already entered tag. The tag input area 72 is an area for displaying an entered tag or a tag that has been selected from among tags displayed in the tag candidate display area 71. The search area 73 is an area clicked when a search command for searching for images having the tag entered in the tag input area 72 is applied. The reset area 74 is an area clicked when the tag entered in the tag input area 72 is reset.

It goes without saying that clicking of a tag displayed in the tag candidate display area 71, clicking of the search area 73 and clicking of the reset area 74 is carried out using a mouse provided as part of the input unit 3. Naturally, it may be so arranged that if a touch-sensitive panel has been formed on the display screen of the display unit 4, these areas, etc. are touched to enter commands, etc., a described above. Further, a tag is entered in the tag input area 72 using a keyboard provided as part of the input unit 3.

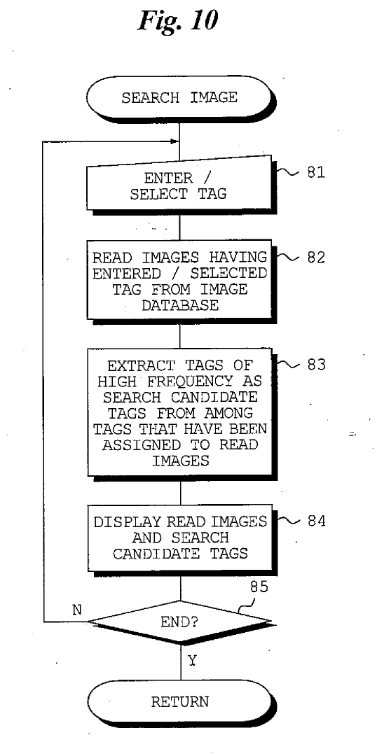

FIG. 10 is a flowchart illustrating image search processing.

When an image search is conducted the first time, tag candidates do not appear in the search window and no images are displayed in the image display area 75, which is for displaying search results. When an image search is conducted the first time, a tag is entered in the tag input area 72 (step 81). When this is done, image data having the entered tag is read from the image database 6 (step 82).

Tags having a high frequency of appearance are extracted as search candidate tags from among tags that have been assigned to the read image data (step 83). Images represented by the read image data are displayed in the image display area 75 of the search window, and the search candidate tags are displayed in the tag candidate display area 71 (step 84).

If the image search is to be continued (“YES” at step 85) processing from step 81 is continued.

If an image search is conducted, tags suitable for finding images relating to images having tags that have already been entered in the tag candidate display area 71 are displayed in the tag candidate display area 71. A tag therefore can be selected from among tags being displayed in the tag candidate display area 71 (step 81). When a tag is selected, images having the selected tag are found (step 82) and search candidate tags are extracted again (step 83). The extracted search candidate tags and the found images are displayed in the search window (step 84). Thus, desired images are found.

By way of example, if, when an image search is conducted the first time, the tag “FOREIGN TRAVEL” is entered in the tag input area 72, image data representing the images of Image ID Nos. 1, 2, 3 and 4 having the tag “FOREIGN TRAVEL” will be read out of the image database 6, as will be understood from FIG. 2. The images represented by the image data read out are displayed in the image display area 75. From among tags with the exception of the tag that has been entered in the tag input area 72, the tags that have been assigned to the image of ID No. 1 are “THAILAND” and “RUINS”, the tags that have been assigned to the image of ID No. 2 are “CAMBODIA” and “RUINS”, the tag that has been assigned to the image of ID No. 3 is “HONG KONG”, and the tags that have been assigned to the image of ID No. 4 are “GOURMET” and “HONG KONG”. Therefore, from among these tags, the tags that have been assigned to the found images with the highest frequency of appearance are the tags “RUINS” and “HONG KONG”, and the tags having the next highest frequency of appearance are “THAILAND” and “CAMBODIA”. Consequently, tags having a high frequency of occurrence greater than a prescribed number are the tags “RUINS”, “HONG KONG”, “THAILAND” and “CAMBODIA”, and these tags are displayed in the tag candidate display area 71 as the tag candidates.

With reference to FIG. 8, if “HONG KONG” is selected as a tag when “RUINS”, “HONG KONG”, “THAILAND” and “CAMBODIA” are being displayed as tag candidates, then, as illustrated in FIG. 9, “FOREIGN TRAVEL” and “GOURMET”, which have a high frequency of appearance among the tags with the exception of “HONG KONG” that has been assigned to images having the tag “HONG KONG”, will become the tag candidates. Furthermore, if “GOURMET” is selected when “FOREIGN TRAVEL” and “GOURMET” are being displayed, then “HONG KONG” and “GINZA”, which have a high frequency of appearance among the tags with the exception of “GOURMET” that has been assigned to images having the tag “GOURMET”, will be displayed as the tag candidates. Thus, desired images can be found as the search progresses.

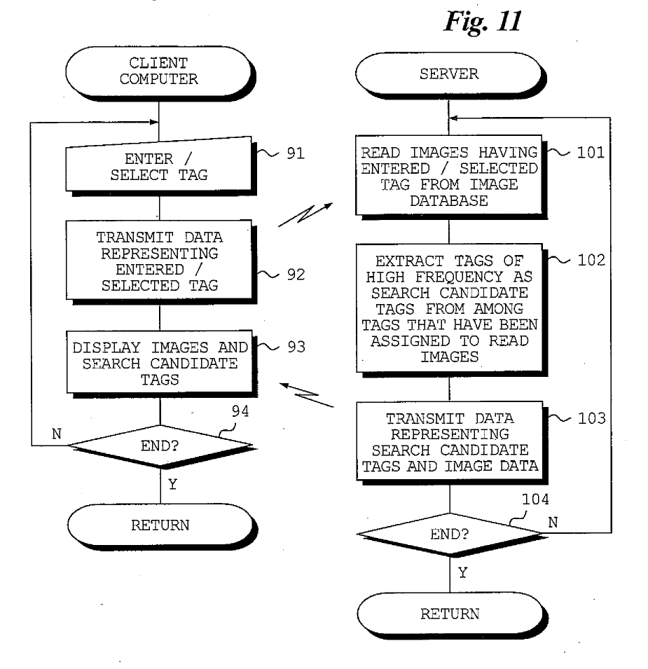

FIG. 11, which illustrates a modification of this embodiment, is a flowchart illustrating processing whereby images are searched by communication between a client computer and a server. This processing is capable of utilizing the system shown in FIG. 6.

A tag is entered by the input unit 32 of the client computer 30 (step 91), and data representing the entered tag is transmitted from the client computer 30 to the server 40 (step 92).

Image data representing images having the tag entered to the client computer 30 are read from the image database 41 (step 101) and, as described above, tags having a high frequency of appearance among the tags that have been assigned to the read images are extracted as search candidate tags (step 102). Data representing the extracted search candidate tags and the image data is transmitted from the server 40 to the client computer 30 (step 103).

The found images and the search candidate tags are displayed at the client computer 30 (step 93). The processing of steps 91 to 93 and the processing of steps 101 to 103 is repeated until search processing ends (steps 94, 104).

If a tag is selected from among the search candidate tags, the processing of steps 92, 93 and of steps 101 to 103 is executed based upon the tag selected.

As many apparently widely different embodiments of the present invention can be made without departing from the spirit and scope thereof, it is to be understood that the invention is not limited to the specific embodiments thereof except as defined in the appended claims.

What is claimed is:

1. A tag designating apparatus comprising:
a first display control device for controlling a display unit so as to display an image of interest, to which a tag representing image attribute information will be assigned, on a display screen;
a second display control device for controlling the display unit in such a manner that second tags different from first tags are displayed on the display screen as tags serving as candidates for assignment to the image of interest, wherein the second tags are from among tags that have been assigned to a number of stored images, other than the image of interest, stored in an image database, these stored images having tags identical with the first tags that have already been assigned to the image of interest; and
a tag designating device for designating a tag, which will be assigned anew to the image of interest, from among the second tags displayed on the display screen by said second display control device.

2. The apparatus according to claim 1, further comprising at least one of:
a tag storage device for storing a tag, which has been designated by said tag designating device, in association with the image of interest; and
a transmitting device for transmitting data, which represents the tag designated by said tag designating device, to a server in association with the image of interest.

3. An image search apparatus comprising:
a tag input device for inputting a tag representing image attribute information;
a first display control device for controlling a display unit in such a manner that images represented by image data, to which the tag that has been input from the tag input device has been assigned, will be displayed on a display screen, wherein the image data is from among image data that has been stored in an image database;
a second display control device for controlling the display unit in such a manner that, from among tags that have been assigned to the images displayed on the display screen under the control of said first display control device, tags with the exception of the tag that has been input from the tag input device are displayed on the display screen as search candidate tags;
a tag designated device for designating a desired search candidate tag from among the search candidate tags displayed on the display screen under the control of said second display control device; and
a third display control device for controlling the display unit in such a manner that images represented by image data to which the tag designated by said tag designating device has been assigned will be displayed on the display screen, the image being from among the image data that has been stored in the image database.

4. A method of controlling operation of a tag designating apparatus, comprising the steps of:
controlling a display unit so as to display an image of interest, to which a tag representing image attribute information will be assigned, on a display screen;
controlling the display unit in such a manner that second tags different from first tags are displayed on the display screen as tags serving as candidates for assignment to the image of interest, wherein the second tags are from among tags that have been assigned to a number of stored images, other than the image of interest, stored in an image database, these stored images having tags identical with the first tags that have already been assigned to the image of interest; and
designating a tag, which will be assigned anew to the image of interest, from among the second tags displayed on the display screen.

5. A method of controlling operation of an image search apparatus, comprising the steps of:
inputting a tag representing image attribute information;
controlling a display unit in such a manner that images represented by image data, to which the tag that has been input has been assigned, will be displayed on a display screen, wherein the image data is from among image data that has been stored in an image database;
controlling the display unit in such a manner that, from among tags that have been assigned to the images displayed on the display screen, tags with the exception of the tag that has been input are displayed on the display screen as search candidate tags;
designating a desired search candidate tag from among the search candidate tags displayed on the display screen; and
controlling the display unit in such a manner that images represented by image data to which the designated tag has been assigned will be displayed on the display screen, the image data being from among the image data that has been stored in the image database.

6. A program for controlling a computer of a tag designating apparatus, comprising the steps of:
controlling a display unit so as to display an image of interest, to which a tag representing image attribute information will be assigned, on a display screen;
controlling the display unit in such a manner that second tags different from first tags are displayed on the display screen as tags serving as candidates for assignment to the image of interest, wherein the second tags are from among tags that have been assigned to a number of stored images, other than the image of interest, stored in an image database, these stored images having tags identical with the first tags that have already been assigned to the image of interest; and
designating a tag, which will be assigned anew to the image of interest, from among the second tags displayed on the display screen.

7. A program for controlling a computer of an image search apparatus, comprising the steps of:
inputting a tag representing image attribute information;
controlling a display unit in such a manner that images represented by image data, to which the tag that has been input has been assigned, will be displayed on a display screen, wherein the image data is from among image data that has been stored in an image database;
controlling the display unit in such a manner that, from among tags that have been assigned to the images displayed on the display screen, tags with the exception of the tag that has been input are displayed on the display screen as search candidate tags;
designating a desired search candidate tag from among the search candidate tags displayed on the display screen; and
controlling the display unit in such a manner that images represented by image data to which the designated tag has been assigned will be displayed on the display screen, the image data being from among the image data that has been stored in the image database.
